(19) United States
(12) Patent Application Publication
(10) Pub. No.: US 2018/0003886 A1
(43) Pub. Date: Jan. 4, 2018

(54) LIGTH SOURCE MODULE AND LIGHT GUIDE PLATE

(71) Applicant: Young Lighting Technology Inc., Hsin-Chu (TW)

(72) Inventors: Ming-Dah Liu, Hsin-Chu (TW); Ming-Ta Ke, Hsin-Chu (TW); Chao-Hung Weng, Hsin-Chu (TW)

(73) Assignee: Young Lighting Technology Inc., Hsin-Chu (TW)

(21) Appl. No.: 15/493,160

(22) Filed: Apr. 21, 2017

(30) Foreign Application Priority Data
Jun. 30, 2016 (CN) 201610504463.0

(51) Int. Cl. F21V 8/00; G02B 5/09

(52) U.S. Cl. CPC G02B 6/0053; G02B 6/0068; G02B 5/09; G02B 6/0018; G02B 6/0036

(57) ABSTRACT

A light source module and a LGP are provided, the light source module includes the LGP, a light source and an optical film. The LGP includes a bottom surface, a light-emitting surface, a light incident surface and a reflection surface. A projection of the reflection surface on the light-emitting surface has an arc shape. The optical film is disposed on the light-emitting surface, and includes a plurality of prism columns in arrangement. The bottom surface has a plurality of microstructures, and each microstructure has a first surface and a second surface. The first surface is closer to the light incident surface compared to the second surface, and an included angle between the first surface and the bottom surface ranges between 1 and 10 degrees. The light source module of the invention effectively narrows horizontal and vertical viewing angles, and light and slim tendency of the light source module is satisfied.

### CROSS-REFERENCE TO RELATED APPLICATION

This application claims the priority benefit of China application serial no. 201610504463.0, filed on Jun. 30, 2016. The entirety of the above-mentioned patent application is hereby incorporated by reference herein and made a part of this specification.

### BACKGROUND OF THE INVENTION

### Field of the Invention

The invention relates to a light source module and a light guide plate.

### Description of Related Art

Liquid crystal displays (LCD) have been widely applied in all respects of people's daily life, for example, information home appliances such as notebook computers, liquid crystal monitors, portable consumer audio and video products, mobile phones and liquid crystal televisions, etc. Since a display panel of the LCD does not emit light itself, a light source module used for providing a light source is one of key components of the LCD.

In related research field of display of recent years, a narrow viewing angle technique gradually draws attention, and a display with a smaller viewing angle may have many applications. The existing narrow viewing angle technique generally adopts a wedge-shaped light guide plate in collaboration with a specific light incident structure and a specific reflection structure to improve light directivity, so as to narrow a horizontal viewing angle. However, the existing narrow viewing angle technique cannot effectively narrow a vertical viewing angle, and is hard to satisfy a demand on related application of the narrow viewing angle.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention was acknowledged by a person of ordinary skill in the art.

### SUMMARY OF THE INVENTION

The invention is directed to a light source module, which is adapted to effectively narrow a horizontal viewing angle and a vertical viewing angle, and satisfy a demand on light and thin tendency of the light source module.

The invention is directed to a light guide plate, and when the light guide plate is applied to a light source module, a horizontal viewing angle and a vertical viewing angle of the light source module is effectively narrowed to satisfy a demand on light and thin tendency of the light source module.

Other objects and advantages of the invention can be further illustrated by the technical features broadly embodied and described as follows.

In order to achieve at least one or a portion of or all of the objects or other objects, an embodiment of the invention provides a light source module including a light guide plate, a light source and an optical film. The light guide plate includes a bottom surface, a light-emitting surface, a light incident surface and a reflection surface. The light-emitting surface is opposite to the bottom surface. The light incident surface is connected to the bottom surface and the light-emitting surface. The reflection surface is opposite to the light incident surface, and a projection of the reflection surface on the light-emitting surface has an arc shape. The light source is disposed beside the light incident surface. The optical film is disposed on the light-emitting surface, and the optical film includes a plurality of prism columns in arrangement. The bottom surface has a plurality of microstructures, and each of the microstructures has a first surface and a second surface. The first surface is closer to the light incident surface compared to the second surface, and an included angle between the first surface and the bottom surface ranges between 1 and 10 degrees.

In order to achieve at least one or a portion of or all of the objects or other objects, an embodiment of the invention provides a light guide plate including a bottom surface, a light-emitting surface, a light incident surface and a reflection surface. The light-emitting surface is opposite to the bottom surface. The light incident surface is connected to the bottom surface and the light-emitting surface. The reflection surface is opposite to the light incident surface, and a projection of the reflection surface on the light-emitting surface has an arc shape. The bottom surface has a plurality of microstructures, and each of the microstructures has a first surface and a second surface. The first surface is closer to the light incident surface compared to the second surface, and an included angle between the first surface and the bottom surface ranges between 1 and 10 degrees.

According to the above description, the embodiments of the invention have at least one of the following advantages or effects. The projection of the reflection surface of the light guide plate of the embodiment of the invention on the light-emitting surface has the arc shape, and the bottom surface of the light guide plate has a plurality of microstructures. The first surface of each of the microstructures is closer to the light incident surface compared to the second surface, and the included angle between the first surface and the bottom surface ranges between 1 and 10 degrees. When the light guide plate is applied to the light source module, the reflection surface with the arc shape may effectively converge a divergence angle of light beam, so as to narrow a horizontal viewing angle of the light source module. Moreover, when the light beam emitted by the light source enters the light guide plate, the microstructures on the bottom surface may reflect the light beam entering the light guide plate through the light incident surface, and meanwhile reflect the light beam reflected by the reflection surface. The light beam reflected by the microstructures is incident to the optical film of the light source module in a large angle, and the prism columns of the optical film convert the large angle light beam to emit a small angle light beam or a vertical angle light beam. Therefore, the vertical viewing angle of the light source module may be effectively narrowed. Moreover, the light guide plate may be designed to be relatively light and thin and may adopt a form of a flat plate, so as to satisfy a demand on light and thin tendency of the light source module.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a light source module according to an embodiment of the invention.

FIG. 1B is a top view of the light source module of FIG. 1A.

FIG. 1C is an enlarged view of a region A of the light source module of FIG. 1A.

FIG. 2 is a comparison diagram of a vertical viewing angle and a horizontal viewing angle of the light source module of FIG. 1A under different included angles between a first surface and a bottom surface.

FIG. 3 is a simulation diagram of a viewing angle distribution of the light source module of FIG. 1A.

FIG. 4 is a top view of a light guide plate according to another embodiment of the invention.

FIG. 5 is a top view of a light guide plate according to still another embodiment of the invention.

FIG. 6A is a top view of a light source module according to still another embodiment of the invention.

FIG. 6B is a simulation diagram of a viewing angle distribution of the light source module of FIG. 6A.

FIG. 6C is a simulation diagram of another viewing angle distribution of the light source module of FIG. 6A.

FIG. 7 is a top view of a light source module according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

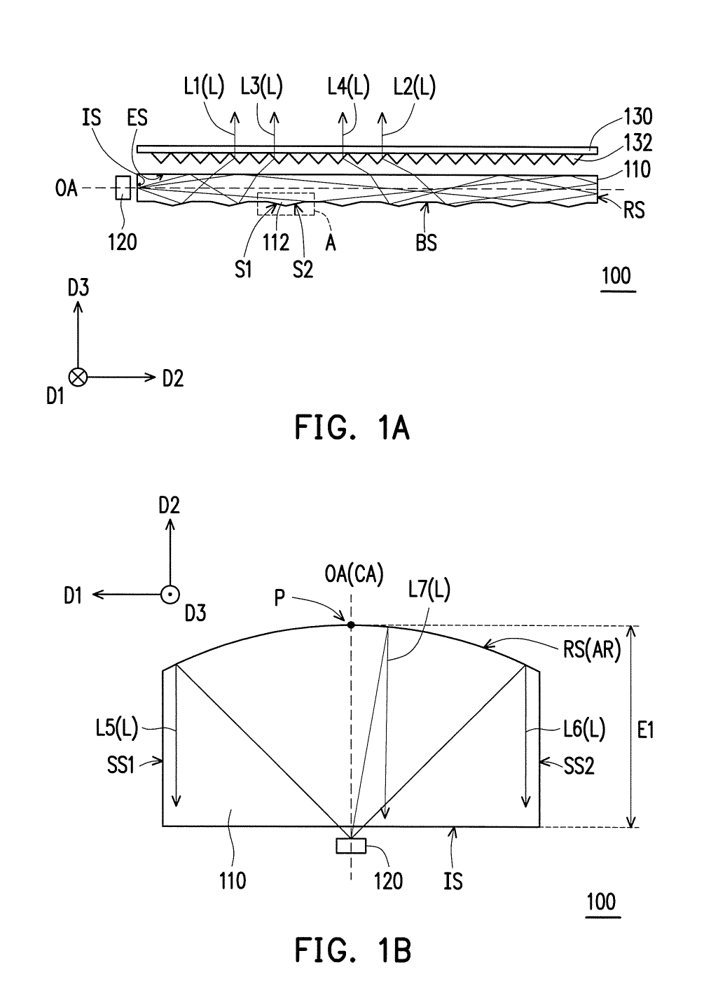

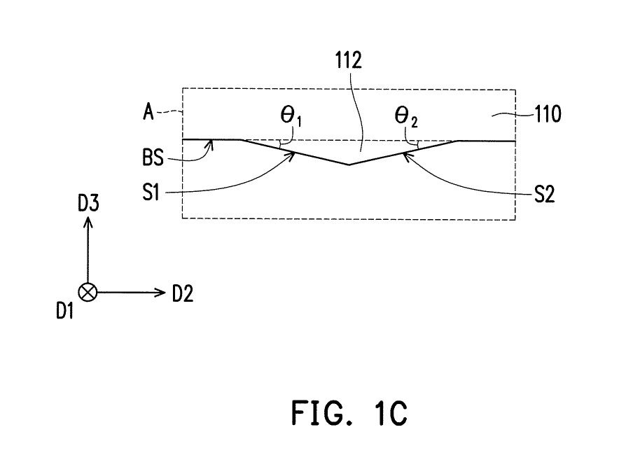

FIG. 1A is a cross-sectional view of a light source module according to an embodiment of the invention. Referring to FIG. 1A, in the embodiment, the light source module 100 includes a light guide plate 110 and a light source 120. The light guide plate 110 includes a light incident surface IS, a light-emitting surface ES, a bottom surface BS, and a reflection surface RS. The reflection surface RS is opposite to the light incident surface IS, and the light-emitting surface ES is opposite to the bottom surface BS. The light incident surface IS is connected to the bottom surface BS and the light-emitting surface ES, and the light source 120 is disposed beside the light incident surface IS. The reflection surface RS is connected to the bottom surface BS and the light-emitting surface ES. In the embodiment, the light guide plate 110 is, for example, flat panel light guide plate, and the light-emitting surface ES of the light guide plate 110 is parallel to the bottom surface BS. However, in other embodiments, the light guide plate 110 may also be a wedge-shaped light guide plate, the light-emitting surface ES of the light guide plate 110 is not parallel to the bottom surface BS, and a distance between the light-emitting surface ES and the bottom surface BS is gradually increased along a direction away from the light incident surface IS (a second direction D2), though the invention is not limited thereto.

In the embodiment, the light beam emitted by the light source 120 enters the light guide plate 110 through the light incident surface IS. To be specific, the light source 120 has an optical axis OA. The light source module 100 is for example, located in a space constructed by a first direction D1, the second direction D2 and a third direction D3, and the first direction D1, the second direction D2 and the third direction D3 are perpendicular to each other, where the first direction D1 is parallel to the light incident surface IS, the second direction D2 is parallel to the optical axis OA, and an arranging direction of the light guide plate 110 and an optical film 130 is parallel to the third direction D3.

In the embodiment, the light source 120 is, for example, a point light source such as a light-emitting diode (LED). However, the light source 120 may also include a plurality of LEDs. In case that the light source 120 includes a plurality of LEDs, the LEDs are arranged along the first direction D1 and are disposed beside the light incident surface IS. Moreover, in other embodiments, the light source 120 may adopt an organic light-emitting diode (OLED) or other suitable light-emitting devices according to an optical requirement of the light source module 100, which is not limited by the invention.

Referring to FIG. 1A, in the embodiment, the light source module 100 further includes the optical film 130, where the optical film 130 is disposed on the light-emitting surface ES, and the optical film 130 includes a plurality of prism columns 132 arranged along a direction, where the optical film 130 is, for example, a reverse prism sheet. For example, the prism columns 132 are arranged along the second direction D2, and the prism columns 132 extend along the first direction D1. Moreover, the prism columns 132 face the light-emitting surface ES. In the embodiment, a function of the reverse prism sheet includes guiding a light beam incident to the reverse prism sheet in a large angle to emit in a forward direction, for example, to emit along a direction parallel to the third direction D3, and the function of the reverse prism sheet also includes guiding a light beam incident to the reverse prism sheet in the forward direction or a small angle to emit in a large angle. The incident light beam with an angle between the forward direction (or the small angle) and the large angle is reflected on a surface of the reverse prism sheet or is reflected in internal of the reverse prism sheet. In the embodiment, a vertex angle of the prism columns 132 is, for example, 68 degrees. Alternatively, the vertex angle of the prism columns 132 may also be other angle. Moreover, in some embodiments, the optical film 130 may also adopt a right prism sheet (the prism columns face away the light-emitting surface ES) or other types of prism sheet, and the light source module 100 may also include an optical film having other function. For example, in the light source module 100, a diffusion sheet may be disposed above the light guide plate 110 according to an optical requirement. The diffusion sheet may be used for uniforming an emitted light beam, such that the light source module 100 has a good optical effect. Alternatively, the light source module 100 may also include other types of optical film to achieve proper optical adjustment.

FIG. 1C is an enlarged view of a region A of the light source module of FIG. 1A. Referring to FIG. 1A and FIG. 1C, in the embodiment, the bottom surface BS has a plurality of microstructures 112, and the microstructures 112 protrude out of the bottom surface BS. Each of the microstructures 112 has a first surface S1 and a second surface S2, and the first surface S1 is closer to the light incident surface IS compared to the second surface S2. To be specific, the first surface S1 and the second surface S2 are, for example, planes, and an included angle θ1 between the first surface S1 and the bottom surface BS within the light guide plate 110 ranges between 1 and 10 degrees. In the embodiment, the included angle θ1 between the first surface S1 and the bottom surface BS is, for example, 2 degrees. Moreover, an included angle θ2 between the second surface S2 and the bottom surface BS within the light guide plate 110 ranges between 1 and 10 degrees. In the embodiment, the included angle θ1 between the first surface S1 and the bottom surface BS is equal to the included angle θ2 between the second surface S2 and the bottom surface BS. However, in other embodiment, the included angle θ1 between the first surface S1 and the bottom surface BS may be different to the included angle θ2 between the second surface S2 and the bottom surface BS. Moreover, in some embodiments, the microstructures 112 may be recessed into the bottom surface BS. In case that the microstructures 112 are recessed into the bottom surface BS, the included angle θ1 between the first surface S1 and the bottom surface BS, for example, ranges between 1 and 10 degrees, and the included angle θ2 between the second surface S2 and the bottom surface BS, for example, ranges between 1 and 10 degrees. To be specific, in the related embodiments, the included angle θ1 and the included angle θ2 may also have other angle range, which is not limited by the invention.

Referring to FIG. 1A, in the embodiment, the light beam L emitted by the light source 120 enters the light guide plate 110 through the light incident surface IS. The light beam L is propagated in the light guide plate 110 in a total reflection manner. When the light beam L is propagated to the microstructures 112, the light beam L is reflected by the microstructures 112 and is further refracted out of the light guide plate 110 at the light-emitting surface ES. Since the first surface S1 and the second surface S2 of each of the microstructures 112 are planes, the microstructures 112 do not scatter the light beam. To be specific, the light beam L includes a light beam L1, a light beam L2, a light beam L3 and a light beam L4. In following description, propagating paths of the light beam L1, the light beam L2, the light beam L3 and the light beam L4 are used for schematically describing propagating paths of different parts of the light beam L. In the embodiment, after the light beam L1 is emitted by the light source 120, the light beam L1 is reflected by the second surfaces S2 of the microstructures 112, and is further refracted out of the light guide plate 110 at the light-emitting surface ES. Then, the light beam L1 enters the optical film 130, and the prism columns 132 of the optical film 130 guide the light beam L1 incident in the large angle to emit in the forward direction or a small angle. Moreover, the light beam L2 is propagated toward the bottom surface BS after it is emitted by the light source 120, and the light beam L2 is reflected between the bottom surface BS and the light-emitting surface ES and is propagated to the reflection surface RS. Then, the light beam L2 is reflected by the reflection surface RS and is returned, and is further reflected by the first surfaces S1 of the microstructures 112. The light beam L2 reflected by the first surfaces S1 is refracted out of the light guide plate 110 at the light-emitting surface ES, and the prism columns 132 of the optical film 130 guide the light beam L2 incident in the large angle to emit in the forward direction or a small angle. Moreover, after the light beam L3 is emitted by the light source 120, the light beam L3 is reflected by the light-emitting surface ES and is propagated toward the bottom surface BS. The light beam L3 is reflected by the second surfaces S2 of the microstructures 112 on the bottom surface BS, and is further refracted out of the light guide plate 110 at the light-emitting surface ES. The prism columns 132 of the optical film 130 guide the light beam L3 incident in the large angle to emit in the forward direction or a small angle. Besides, the light beam L4 is propagated toward the light-emitting surface ES after it is emitted by the light source 120, and the light beam L4 is reflected between the light-emitting surface ES and the bottom surface BS and is propagated to the reflection surface RS. Then, the light beam L4 is reflected by the reflection surface RS and is returned, and is further reflected by the first surfaces S1 of the microstructures 112. The light beam L4 reflected by the first surfaces S1 is refracted out of the light guide plate 110 at the light-emitting surface ES, and the prism columns 132 of the optical film 130 guide the light beam L4 incident in the large angle to emit in the forward direction or a small angle.

To be specific, the light guide plate 110 has the microstructures 112, and the light source module 100 has the optical film 130 disposed corresponding to the microstructures 112. A part of the light beam L that is emitted out of the light-emitting surface ES before reaching the reflection surface RS (for example, the light beam L1 and the light beam L3) may be guided by the prism columns 132 of the optical film 130 to emit in the forward direction or a small angle. Moreover, a part of the light beam L that is emitted out of the light-emitting surface ES after being returned from the reflection surface RS (for example, the light beam L2 and the light beam L4) may also be guided by the prism columns 132 of the optical film 130 to emit in the forward direction or a small angle. Therefore, the part of light beam L without reaching the reflection surface RS or the part of light beam L after being returned from the reflection surface RS may all be emitted out of the optical film 130 in the forward direction or a small angle through configuration of the microstructures 112 and configuration of the optical film 130, such that a vertical viewing angle of the light source module 100 may be effectively narrowed. The vertical viewing angle refers to a viewing angle along the vertical direction, and the vertical direction is parallel to the second direction D2. Moreover, in some embodiments, a reflection element may be disposed at a side of the bottom surface BS of the light guide plate 110. In these embodiments, even if the light beam L may not be propagated in a total internal reflection manner in the light guide plate 110 (for example, an incident angle of the light beam L on the bottom surface BS is smaller than a threshold angle) and is emitted out from the bottom surface BS, the light beam L may still be reflected to the corresponding light-emitting surface ES by the reflection element, and the invention is not limited thereto.

FIG. 1B is a top view of the light source module of FIG. 1A. In order to clearly present a shape of the light guide plate 110 of the light source module 100, the optical film 10 is omitted in FIG. 1B. Referring to FIG. 1A and FIG. 1B, in the embodiment, the light guide plate 110 further includes a side surface SS1 and a side surface SS2. The side surface SS1 is connected between the light incident surface IS and the reflection surface RS, and the side surface SS2 is also connected between the light incident surface IS and the reflection surface RS. Moreover, the side surface SS1 is further connected between the bottom surface BS and the light-emitting surface ES, and the side surface SS2 is also connected between the bottom surface BS and the light-emitting surface ES. In the embodiment, a projection of the reflection surface RS on the light-emitting surface ES has an arc shape AR (for example, an arc shape shown in FIG. 1B). The reflection surface RS with the arc shape AR has a central axis CA, and the central axis CA, for example, passes through a center of curvature of the arc shape AR. The light source 120 is located on the central axis CA of the reflection surface RS, and the optical axis OA of the light source 120 is coincided with the central axis CA. Moreover, in other embodiments, the light source 120 may also be disposed by deviating from the central axis CA according to an actual optical requirement, which is not limited by the invention.

In the embodiment, the reflection surface RS is a surface protruding out of the light guide plate 110, and a distance E1 between the light incident surface IS and the reflection surface RS is equal to a half of the radius of curvature of the arc shape AR. To be specific, the central axis CA passes through a position P on the reflection surface RS, and the distance E1 between the light incident surface IS and the position P in the second direction D2 is equal to a half of the radius of curvature of the arc shape AR. For example, in an embedment, the radius of curvature of the arc shape AR of the reflection surface RS is, for example, 200 mm, and a length of the light guide plate 110 in the first direction D1 is, for example, 100 mm. Moreover, a length of the light guide plate 110 in the second direction D2, i.e. the distance E1 between the light incident surface IS and the position P in the second direction D2 is, for example, 100 mm. However, an actual dimension of the light guide plate 110 may be adjusted according to an actual optical requirement, which is not limited by the invention.

In the embodiment, the light source 120 is, for example, very close to the light incident surface IS, or has a tiny and negligible distance with the light incident surface IS, so that the position of the light source 120 may be regarded as a focus position of the reflection surface RS with the arc shape AR. To be specific, the light beam L further includes a light beam L5, a light beam L6 and a light beam L7. Propagating paths of the light beam L5, the light beam L6 and the light beam L7 are used for schematically describing propagating paths of different parts of the light beam L. The light beam L5 is propagated along a direction including a large angle with the second direction D2 after being emitted by the light source 120. The light beam L5 is reflected back and forth between the bottom surface BS and the light-emitting surface ES and is propagated to a part of the reflection surface RS located at a side of the central axis CA. Then, the light beam L5 is reflected by the reflection surface RS, and is returned along a direction parallel to the second direction D2, or along a direction including a small angle with the second direction D2. Moreover, the light beam L6 is propagated along a direction including a large angle with the second direction D2 after being emitted by the light source 120. The light beam L6 is reflected back and forth between the bottom surface BS and the light-emitting surface ES and is propagated to a part of the reflection surface RS located at another side of the central axis CA. Then, the light beam L6 is reflected by the reflection surface RS, and is returned along a direction parallel to the second direction D2, or along a direction including a small angle with the second direction D2. Besides, the light beam L7 is propagated along a direction including a small angle with the second direction D2 or a long a direction parallel to the second direction D2 after being emitted by the light source 120. The light beam L7 is reflected back and forth between the bottom surface BS and the light-emitting surface ES and is propagated to a part of the reflection surface RS close to the central axis CA. Then, the light beam L7 is reflected by the reflection surface RS, and is returned along a direction parallel to the second direction D2, or along a direction including a small angle with the second direction D2.

To be specific, by designing the distance E1 between the light incident surface IS and the reflection surface RS to be equal to the half of the radius of curvature of the arc shape AR, after the light beam L emitted by the light source 120 and diverged toward the reflection surface RS is reflected by the reflection surface RS with the arc shape AR, the light beam L is returned along a direction parallel to the second direction D2, or along a direction including a small angle with the second direction D2. Therefore, the reflection surface RS with the arc shape AR may effectively converge a divergence angle of the light beam L, so as to narrow a horizontal viewing angle of the light source module 100. The horizontal viewing angle refers to a viewing angle along the horizontal direction, and the horizontal direction is parallel to the first direction D1. In some embodiments, other distance values may be designed between the light incident surface IS and the reflection surface RS according to an actual optical requirement. Moreover, in the embodiment, a shape of a projection of the reflection surface RS on the side surface SS1 or a shape of a projection of the reflection surface RS on the side surface SS2 is a straight line. However, in some embodiments, the shape of the projection of the reflection surface RS on the side surface SS1 or the shape of the projection of the reflection surface RS on the side surface SS2 may also be an arc shape or other shapes. Moreover, the reflection surface RS may be designed to have protruding or recessed microstructures according to an actual optical requirement, which is not limited by the invention.

In the embodiment, the reflection surface RS with the arc shape AR may effectively converge a divergence angle of the light beam L, so as to narrow the horizontal viewing angle of the light source module 100. Moreover, the microstructures 112 on the bottom surface BS of the light guide plate 110 respectively have the first surface S1 and the second surface S2 set in specific angles, and in collaboration with the optical film 130 having the arranged prism columns 132, the microstructures 112 may reflect the light beam L entering the light guide plate 110 from the light incident surface IS, and meanwhile reflect the light beam L reflected by the reflection surface RS. The light beam L reflected by the microstructures 112 is incident to the optical film 130 in a large angle, and the prism columns 132 of the optical film 130 guide the light beam L incident in the large angle to emit in a small angle or in the vertical direction. Therefore, the vertical viewing angle of the light source module 100 may be effectively narrowed. Moreover, the light guide plate 110 may adopt a light and thin flat panel light guide plate without adopting the wedge-shaped light guide plate. Therefore, besides that the light source module 100 may achieve a narrow viewing angle effect in both of the horizontal direction and the vertical direction, a demand on light and thin tendency thereof is also satisfied. To be specific, when a display is used in collaboration with the light source module 100 with the narrow viewing angle effect, the display has a smaller viewing angle and is adapted to multiple applications, for example, application in anti-peep or vehicle display, etc. Moreover, since the display having the smaller viewing angle have a convergent light-emitting effect, a brightness demand thereof may be satisfied in case that a light source with a smaller power is adopted, so as to reduce a power consumption of the display.

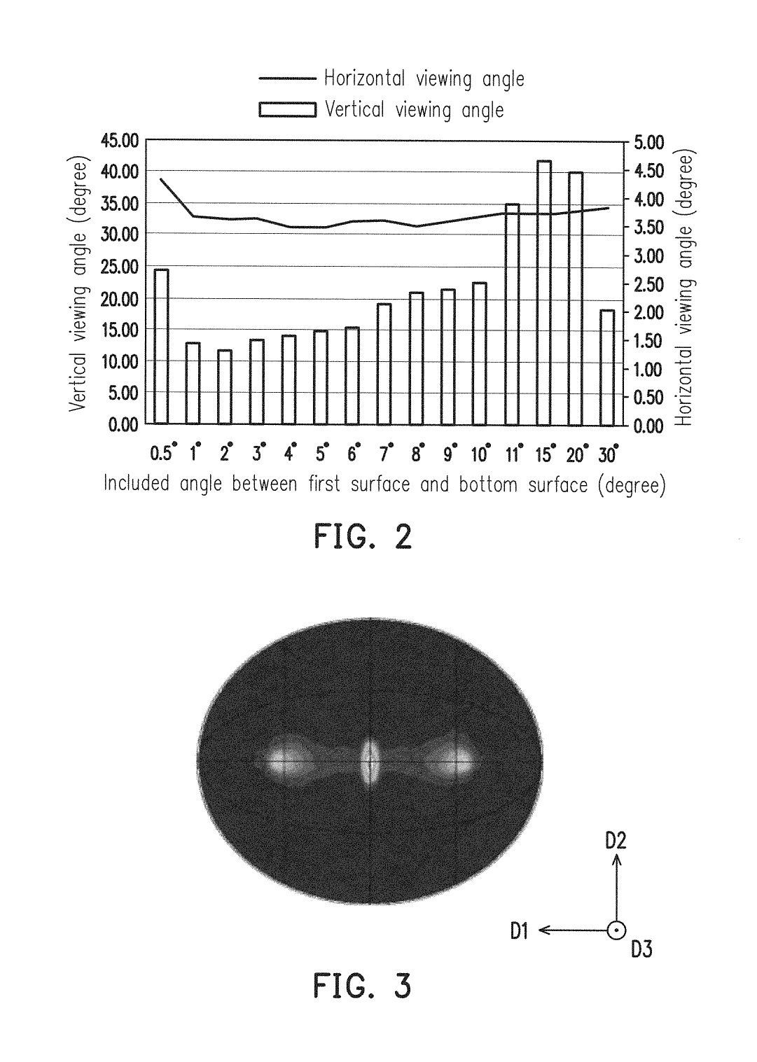

FIG. 2 is a comparison diagram of the vertical viewing angle and the horizontal viewing angle of the light source module of FIG. 1A under different included angles between the first surface and the bottom surface. Moreover, a following table one lists simulation values corresponding to the horizontal viewing angle of the light source module 100 when the included angle θ1 between the first surface S1 of each of the microstructures 112 and the bottom surface BS is set to different values. It should be noted that the data listed in the following table one and the comparison diagram of FIG. 2 are simulation results, and are not used for limiting the invention, and after referring to the description of the invention, any of those skilled in the art may suitably change parameters or settings of the invention according to the principle of the invention without departing from the scope or spirit of the invention.

TABLE ONE

| | Included angle θ1 (degree) | | | | | | | |
|---|---|---|---|---|---|---|---|---|
| | 0.5 | 1 | 2 | 3 | 4 | 5 | 6 | 7 |
| Horizontal | 4.31 | 3.64 | 3.60 | 3.62 | 3.46 | 3.47 | 3.58 | 3.59 |
| viewing angle | | | | | | | | |
| (degree) | | | | | | | | |
| Vertical | 24.21 | 13.2 | 11.6 | 13.29 | 14.05 | 14.79 | 15.31 | 19.14 |
| viewing angle | | | | | | | | |
| (degree) | | | | | | | | |

| | Included angle θ1 (degree) | | | | | | |
|---|---|---|---|---|---|---|---|
| | 8 | 9 | 10 | 11 | 15 | 20 | 30 |
| Horizontal viewing | 3.49 | 3.59 | 3.67 | 3.74 | 3.72 | 3.75 | 3.83 |
| angle (degree) | | | | | | | |
| Vertical viewing | 20.95 | 21.44 | 22.56 | 29.89 | 41.6 | 40.02 | 18.27 |
| angle (degree) | | | | | | | |

To be specific, a longitudinal axis of FIG. 2 and the “vertical viewing angle” shown in the table one represent the vertical viewing angle simulated by the light source module 100, and a unit thereof is degree. A longitudinal axis of FIG. 2 and the “horizontal viewing angle” shown in the table one represent the horizontal viewing angle simulated by the light source module 100, and a unit thereof is degree. Moreover, a lateral axis of FIG. 2 and the “included angle θ1” shown in the table one represents the included angle θ1 (shown in FIG. 1C) between the first surface S1 of each microstructure 112 and the bottom surface BS of the light source module 100, and a unit thereof is degree. According to FIG. 2 and the table one, it is known that when the included angle θ1 between the first surface S1 and the bottom surface BS is set to different values, a variation of the horizontal viewing angle of the light source module 100 is relatively small, and a variation of the vertical viewing angle of the light source module 100 is relatively large. Apparently, when the included angle θ1 between the first surface S1 and the bottom surface BS falls within a range between 1 and 10 degrees, the light source module 100 have narrower vertical viewing angle. To be specific, when the included angle θ1 between the first surface S1 and the bottom surface BS is 2 degrees, the light source module 100 may have the minimum vertical viewing angle. Meanwhile, the horizontal viewing angle of the light source module 100 is not excessively large. In the embodiment, when the included angle θ1 between the first surface S1 and the bottom surface BS is equal to the included angle θ2 between the second surface S2 and the bottom surface BS, and the included angle θ1 is 2 degrees, the vertical viewing angle of the light source module 100 is, for example, 11.6 degrees, and the horizontal viewing angle of the light source module 100 is, for example, 3.6 degrees.

FIG. 3 is a simulation diagram of a viewing angle distribution of the light source module of FIG. 1A. In the simulation result of the viewing angle distribution of the light source module 100 of the embodiment of FIG. 3, the included angle θ1 between the first surface S1 and the bottom surface BS is designed to be 2 degrees. Moreover, different color distribution of FIG. 3 presents the viewing angle distribution of the light source module 100. To be specific, according to FIG. 3, the light beam emitted from the light source module 100 is concentrated in the center, and the light source module 100 has the narrow viewing angle effect in both of the horizontal direction (for example, the first direction D1) and the vertical direction (for example, the second direction D2).

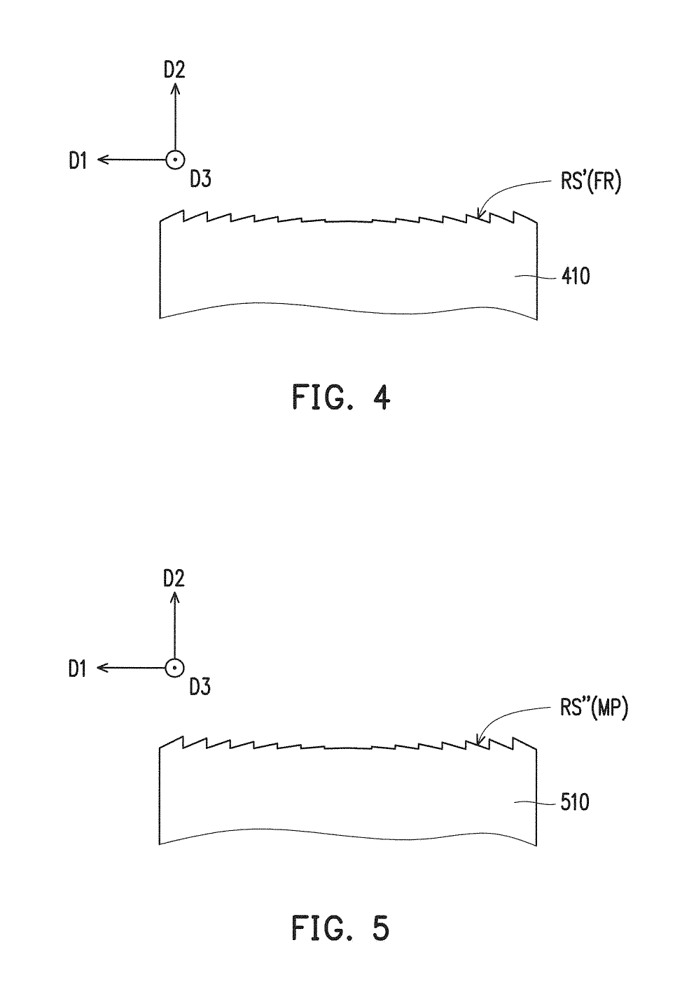

FIG. 4 is a top view of a light guide plate according to another embodiment of the invention. Referring to FIG. 4, in the embodiment, the light guide plate 410 is similar to the light guide plate 110 of the embodiment of FIG. 1A. The components of the light guide plate 410 and related descriptions thereof may refer to the components of the light guide plate 110 of the embodiment of FIG. 1A and related descriptions thereof, and details thereof are not repeated. A difference between the light guide plate 410 and the light guide plate 110 is that a projection of the reflection surface RS' of the light guide plate 410 on the light-emitting surface (not shown) has a Fresnel mirror shape FR. To be specific, the Fresnel mirror shape FR is a shape of a reflection surface of a Fresnel mirror. An optical reflection property of the reflection surface RS' having the Fresnel minor shape FR is, for example, equivalent to that of the reflection surface RS with the arc shape AR of the embodiment of FIG. 1B. In this way, when the light guide plate 410 is applied to the light source module, the reflection surface RS' may effectively converge a divergence angle of a light beam, so as to narrow the horizontal viewing angle of the light source module, and reduce a dimension of the light guide plate 410 in the second direction D2.

FIG. 5 is a top view of a light guide plate according to still another embodiment of the invention. Referring to FIG. 5, in the embodiment, the light guide plate 510 is similar to the light guide plate 110 of the embodiment of FIG. 1A. The components of the light guide plate 510 and related descriptions thereof may refer to the components of the light guide plate 110 of the embodiment of FIG. 1A and related descriptions thereof, and details thereof are not repeated. A difference between the light guide plate 510 and the light guide plate 110 is that the reflection surface RS″ of the light guide plate 510 includes a plurality of inclined micro prism surfaces MP, and a projection of the reflection surface RS″ on the light-emitting surface (not shown) has a sawtooth shape. To be specific, the reflection surface RS″ having the micro prism surfaces MP is, for example, equivalent to the reflection surface RS with the arc shape AR of the embodiment of FIG. 1B. In this way, when the light guide plate 510 is applied to the light source module, the reflection surface RS″ may effectively converge a divergence angle of a light beam, so as to narrow the horizontal viewing angle of the light source module, and reduce a dimension of the light guide plate 510 in the second direction D2.

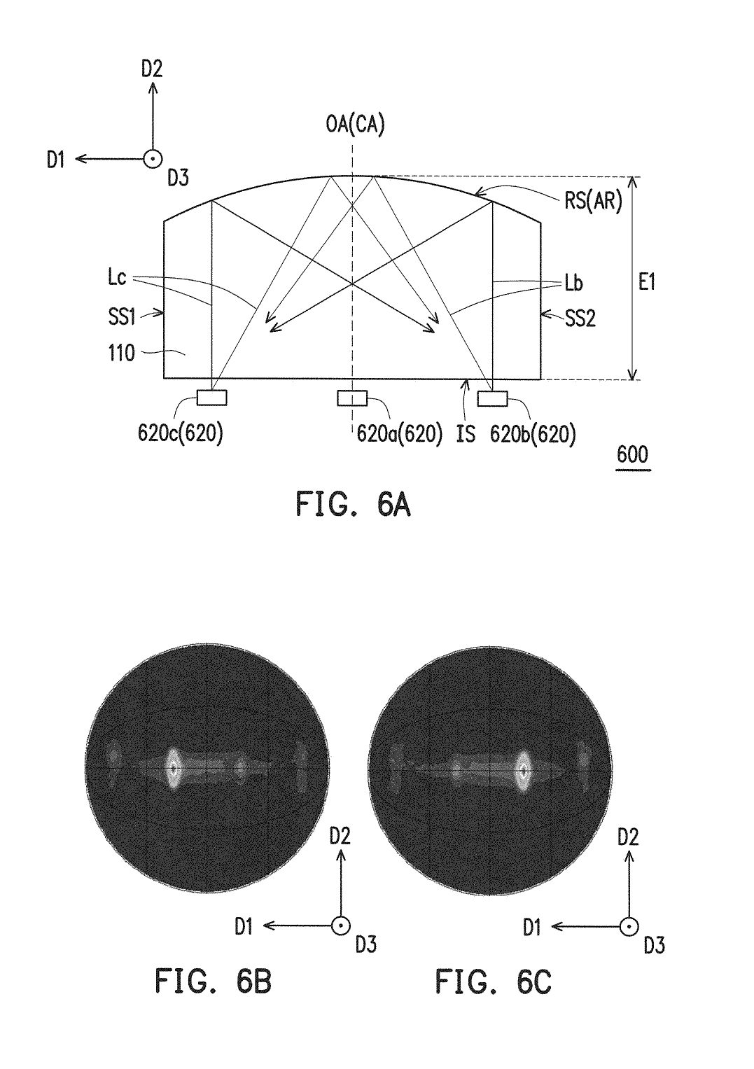

FIG. 6A is a top view of a light source module according to still another embodiment of the invention. Referring to FIG. 6A, in the embodiment, the light source module 600 is similar to the light source module 100 of the embodiment of FIG. 1A. The components of the light source module 600 and related descriptions thereof may refer to the components of the light source module 100 of the embodiment of FIG. 1A and related descriptions thereof, and details thereof are not repeated. A difference between the light source module 600 and the light source module 100 is that the light source 620 of the light source module 600 includes a plurality of sub light sources 620a, 620b and 620c arranged along a direction parallel to the light incident surface IS and the light emitting surface (not shown), and at least a part of the sub light sources 620a, 620b and 620c is deviated from the central axis CA of the reflection surface RS. To be specific, the sub sight sources 620a, 620b and 620c are, for example, arranged along the first direction D1. The sub light source 620a is located on the central axis CA, and the sub light source 620b and the sub light source 620c are respectively located two sides of the central axis CA.

FIG. 6B is a simulation diagram of a viewing angle distribution of the light source module of FIG. 6A, and FIG. 6C is a simulation diagram of another viewing angle distribution of the light source module of FIG. 6A. Referring to FIG. 6A, FIG. 6B and FIG. 6C, in the embodiment, a propagating path of the light beam emitted by the sub light source 620a on the central axis CA is similar to the propagating path of the light beam emitted by the light source 120 of the embodiment of FIG. 1B. Moreover, a light beam Lb emitted by the sub light source 620b deviating from the central axis CA is reflected by the reflection surface RS with the arc shape AR to return. The light beam Lb reflected by the reflection surface RS is propagated to another side of the central axis CA that is away from a position of the sub light source 620b. Therefore, when only the sub light source 620b is turned on, and the sub light source 620a and the sub light source 620c are not turned on, the light source module 600 presents the viewing angle distribution as shown in FIG. 6B. The viewing angle distribution of the light source module 600 presented in FIG. 6B is obviously deviated from the center. Moreover, a light beam Lc emitted by the sub light source 620c deviating from the central axis CA is reflected by the reflection surface RS with the arc shape AR to return. The light beam Lc reflected by the reflection surface RS is propagated to another side of the central axis CA that is away from a position of the sub light source 620c. Therefore, when only the sub light source 620c is turned on, and the sub light source 620a and the sub light source 620b are not turned on, the light source module 600 presents the viewing angle distribution as shown in FIG. 6C. The viewing angle distribution of the light source module 600 presented in FIG. 6C is obviously deviated from the center.

To be specific, in the embodiment, the light source module 600 may be configured with a plurality of sub light sources, and at least a part of the sub light sources is deviated from the central axis CA of the reflection surface RS. By controlling the part of the sub light sources to emit light beam, the viewing angle distribution of the light source module 600 may be adjusted to be deviated from or not deviated from the center, or the a deviation direction or a deviation degree of the viewing angle distribution of the light source module 600 is adjusted. In this way, the light source module 600 may be used in collaboration with a proper display module to provide corresponding display images for different viewing angles, so as to implement related application of multi-viewing angle display. Alternatively, the light source module 600 may also be used in collaboration with a proper display module to provide different display images for two eyes of a user, so as to implement a three-dimensional display effect or other applications. Moreover, since the bottom surface of the light guide plate 110 of the light source module 600 is also configured with the microstructures (not shown) similar to the embodiment of FIG. 1A, and the light source module 600 also includes the optical film (shown) similar to the embodiment of FIG. 1A, through a proper light source configuration, the light source module 600 may also implement the effect similar to that of the slight source module 100 of the embodiment of FIG. 1A to have the narrow viewing angle effect in both of the horizontal direction and the vertical direction, and the light source module 600 may satisfy a demand on the light and thin tendency thereof.

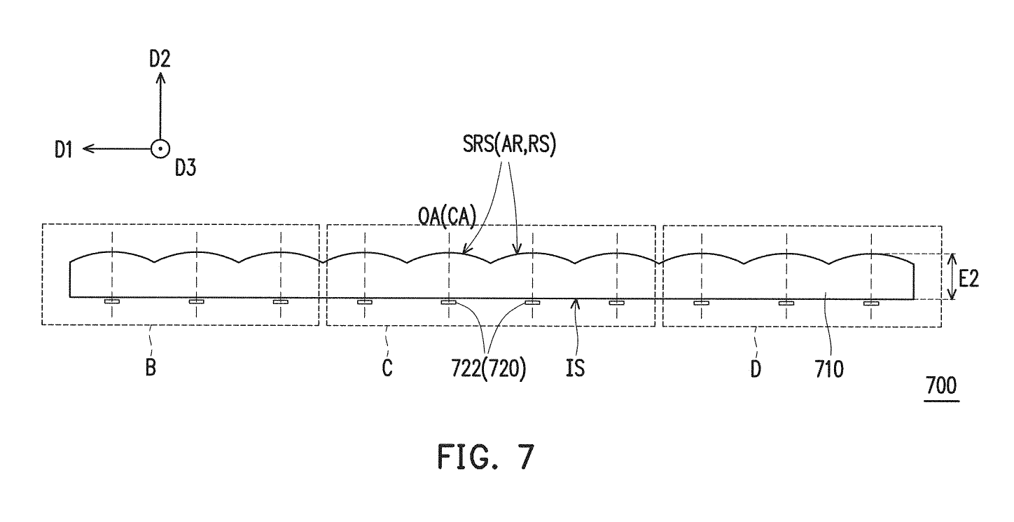

FIG. 7 is a top view of a light source module according to another embodiment of the invention. Referring to FIG. 7, in the embodiment, the light source module 700 is similar to the light source module 100 of the embodiment of FIG. 1A. The components of the light source module 700 and related descriptions thereof may refer to the components of the light source module 100 of the embodiment of FIG. 1A and related descriptions thereof, and details thereof are not repeated. A difference between the light source module 700 and the light source module 100 is that the light source 720 of the light source module 700 includes a plurality of sub light sources 722 arranged along a direction parallel to the light incident surface IS and the light-emitting surface (not shown), and the reflection surface RS of the light guide plate 710 of the light source module 700 includes a plurality of sub reflection surfaces SRS arranged along the above direction. To be specific, the sub light sources 722 are, for example, arranged along the first direction D1, and the sub reflection surfaces SRS are also, for example, arranged along the first direction D1. Moreover, a projection of each of the sub reflection surfaces SRS on the light-emitting surface (not shown) has an arc shape AR, and each of the sub light sources 722 corresponds to one sub reflection surface SRS.

To be specific, the arc shape AR of each of the sub reflection surface SRS has a central axis CA, and the central axis CA, for example, passes through a center of curvature of the arc shape AR. Each of the sub light sources 722 is located on the central axis CA of one sub reflection surface SRS, and the optical axis OA of each of the sub light sources 722 is coincided with the central axis CA of one sub reflection surface SRS. Moreover, in the second direction D2, a distance E2 between the light incident surface IS and the sub reflection surface SRS of the light source module 700 is equal to a half of a radius of curvature of the arc shape AR of the sub reflection surface SRS. In the embodiment, each of the sub reflection surfaces SRS with the arc shape AR may effectively converge a divergence angle of a light beam emitted by a sub light source 722, so as to narrow an overall horizontal viewing angle of the light source module 700. Moreover, the viewing angle distribution of the light source module 700 may also be adjusted. For example, the light source module 700 may, for example, divided into a region B, a region C and a region D. The region C is located at the center of the light guide plate 710, and the region B and the region D are respectively located at two sides of the light guide plate 710. When only the sub light sources 722 located in the region C are controlled to emit light beams, and the sub light sources 722 located in the region B and the region D are controlled not to emit light beam, the overall viewing angle distribution of the light source module 700 is substantially not deviated from the center. When only the sub light sources 722 located in the region B (or the region D) are controlled to emit light beams, and the sub light sources 722 located in the region C and the region D (or the region B) are controlled not to emit light beam, the overall viewing angle distribution of the light source module 700 is deviated from the center. Therefore, by designing a proper number of the sub light sources 722, designing a proper shape of the light guide plate 710 and control a part of the sub light sources 722 to emit light beams, the viewing angle distribution of the light source module 700 may be adjusted to be deviated from or not deviated from the center, or the a deviation direction or a deviation degree of the viewing angle distribution of the light source module 700 is adjusted, so as to implement different applications. Moreover, since the bottom surface of the light guide plate 710 of the light source module 700 is also configured with the microstructures (not shown) similar to the embodiment of FIG. 1A, and the light source module 700 also includes the optical film (shown) similar to the embodiment of FIG. 1A, the light source module 700 may also implement the effect similar to that of the slight source module 100 of the embodiment of FIG. 1A to have the narrow viewing angle effect in both of the horizontal direction and the vertical direction, and the light source module 700 may satisfy the demand on light and thin tendency thereof.

In summary, the embodiments of the invention have at least one of the following advantages or effects. The projection of the reflection surface of the light guide plate of the embodiment of the invention on the light-emitting surface has the arc shape, and the bottom surface of the light guide plate has a plurality of microstructures. The first surface of each of the microstructures is closer to the light incident surface compared to the second surface, and the included angle between the first surface and the bottom surface ranges between 1 and 10 degrees. When the light guide plate is applied to the light source module, the reflection surface with the arc shape may effectively converge a divergence angle of light beam, so as to narrow a horizontal viewing angle of the light source module. Moreover, when the light beam emitted by the light source enters the light guide plate, the microstructures on the bottom surface may reflect the light beam entering the light guide plate through the light incident surface, and meanwhile reflect the light beam reflected by the reflection surface. The light beam reflected by the microstructures is incident to the optical film of the light source module in a large angle, and the prism columns of the optical film convert the large angle light beam to emit a small angle light beam or a vertical angle light beam. Therefore, the vertical viewing angle of the light source module may be effectively narrowed. Moreover, the light guide plate may be designed to be relatively light and thin and may adopt a form of a flat plate, so as to satisfy a demand on light and thin tendency of the light source module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
a light guide plate, comprising:
a bottom surface,
a light-emitting surface, opposite to the bottom surface;
a light incident surface, connected to the bottom surface and the light-emitting surface; and
a reflection surface, opposite to the light incident surface, wherein a projection of the reflection surface on the light-emitting surface has an arc shape;
a light source, disposed beside the light incident surface; and
an optical film, disposed on the light-emitting surface, and comprising a plurality of prism columns in arrangement,
wherein the bottom surface has a plurality of microstructures, and each of the microstructures has a first surface and a second surface, the first surface is closer to the light incident surface compared to the second surface, and an included angle between the first surface and the bottom surface ranges between 1 and 10 degrees.

2. The light source module as claimed in claim 1, wherein the projection of the reflection surface on the light-emitting surface has a Fresnel mirror shape.

3. The light source module as claimed in claim 1, wherein the light source comprises a plurality of sub light sources, the sub light sources are arranged along a direction parallel to the light incident surface and the light-emitting surface, and at least a part of the sub light sources is deviated from a central axis of the reflection surface.

4. The light source module as claimed in claim 1, wherein the light source comprises a plurality of sub light sources, the sub light sources are arranged along a direction parallel to the light incident surface and the light-emitting surface, the reflection surface comprises a plurality of sub reflection surfaces, the sub reflection surfaces are arranged along the direction, a projection of each of the sub reflection surfaces on the light-emitting surface has an arc shape, and each of the sub light sources corresponds to one of the sub reflection surfaces.

5. The light source module as claimed in claim 1, wherein a distance between the light incident surface and the reflection surface is equal to a half of a radius of curvature of the arc shape.

6. The light source module as claimed in claim 1, wherein the microstructures protrude out of or recessed into the bottom surface.

7. The light source module as claimed in claim 1, wherein the included angle between the first surface and the bottom surface is equal to an included angle between the second surface and the bottom surface.

8. A light guide plate, comprising:
a bottom surface;
a light-emitting surface, opposite to the bottom surface;
a light incident surface, connected to the bottom surface and the light-emitting surface; and
a reflection surface, opposite to the light incident surface, wherein a projection of the reflection surface on the light-emitting surface has an arc shape,
wherein the bottom surface has a plurality of microstructures, and each of the microstructures has a first surface and a second surface, the first surface is closer to the light incident surface compared to the second surface, and an included angle between the first surface and the bottom surface ranges between 1 and 10 degrees.

9. The light guide plate as claimed in claim 8, wherein the projection of the reflection surface on the light-emitting surface has a Fresnel mirror shape.

10. The light guide plate as claimed in claim 8, wherein the reflection surface comprises a plurality of sub reflection surfaces, the sub reflection surfaces are arranged along a direction parallel to the light incident surface and the light-emitting surface, and a projection of each of the sub reflection surfaces on the light-emitting surface has an arc shape.

11. The light guide plate as claimed in claim 8, wherein a distance between the light incident surface and the reflection surface is equal to a half of a radius of curvature of the arc shape.

12. The light guide plate as claimed in claim 8, wherein the microstructures protrude out of or recessed into the bottom surface.

13. The light guide plate as claimed in claim 8, wherein the included angle between the first surface and the bottom surface is equal to an included angle between the second surface and the bottom surface.
